(19) United States
(12) Patent Application Publication
(10) Pub. No.: US 2017/0251324 A1
(43) Pub. Date: Aug. 31, 2017

(54) REPRODUCING AUDIO SIGNALS IN A MOTOR VEHICLE

(71) Applicants: Bertrand Stelandre, Thimister (BE); Alexander Van Laack, Aachen (DE); Axel Torschmied, Koln (DE)

(72) Inventors: Bertrand Stelandre, Thimister (BE); Alexander Van Laack, Aachen (DE); Axel Torschmied, Koln (DE)

(21) Appl. No.: 15/443,281

(22) Filed: Feb. 27, 2017

(30) Foreign Application Priority Data
Feb. 25, 2016 (DE) 10 2016 103 331 6

(51) Int. Cl. H04S 7/00; H04R 5/04; B60Q 9/00; H04R 5/02

(52) U.S. Cl. CPC H04S 7/303; H04R 5/02; H04R 5/04; B60Q 9/00; H04R 2499/13; H04S 2400/11; H04S 2400/01

(57) ABSTRACT

The aspects disclosed herein are related to detecting an audio source (such as a sound generated from within or outside a vehicle), establishing a location of the audio source, and employing techniques to replicate the sounds associated with the audio source as a virtual sound within the vehicle. The aspects disclosed herein allow for

### CROSS REFERENCE TO RELATED APPLICATION

This application claims priority to German Patent application no. 10 2016 103 331 6, filed Feb. 25, 2016, entitled “Device and Method for Reproducing Audio Signals in a Motor Vehicle,” now pending, the entire disclosure of the application being considered part of the disclosure of this application and hereby incorporated by reference.

### BACKGROUND

The invention relates to a device for reproducing audio signals in a passenger compartment of a motor vehicle. The device comprises sensors for acquiring the surroundings of the motor vehicle, at least one audio source and at least one loudspeaker for the emission of audio signals.

The invention furthermore relates to a method for reproducing audio signals with at least one virtual sound object by means of the device according to the invention.

In systems known from the prior art, multiple sound channels are mixed together to produce stereo sounds, that is to say stereophonic sounds, and emitted for the listener. In the process, an adjusted sound mix is produced, which indeed generates a pseudo-three-dimensional sound but not a real sensation of space and locatability of the signal. In the motor vehicle, audio signals, for example, speech information of a navigation system, of a telephone or of a radio, or music, are emitted from a central location. Since humans, as listeners, tend to establish eye contact with the speaker during a conversation, the gaze of the driver of the vehicle turns toward the speaker and thus toward the central audio signal emitting site. As a result, the attention of the driver is impaired. The driver, particularly the driver's gaze, is turned away from the roadway. In addition, it is exceedingly difficult to distinguish multiple sound channels that have been mixed together to form stereo sounds.

U.S. Pat. No. 7,970,539 A1 discloses a method for voice guidance and a navigation system with a three-dimensional sound with a direction characteristic for a motor vehicle. The method comprises the determination of the travel direction and of the target direction of the motor vehicle based on navigation data, the calculation of an angle between the travel direction and the target direction, as well as the generation of a three-dimensional direction guidance sound. Here, the system comprises a speech guidance processor coupled to a loudspeaker unit, with a unit for generating the three-dimensional sound. The emission of the three-dimensional sound is based on the head related transfer function, abbreviated HRTF, as a special acoustic transfer function, and the precise position of the head of the driver of the vehicle.

U.S. Pat. No. 8,948,414 B2 discloses a device and a method for emitting acoustic signals for the driver of a motor vehicle who senses that the acoustic signals have been emitted by a sound system that is arranged in the viewing direction or in the travel direction. The driver interacts with the audio source without moving the head. The position of the head is determined by means of sensors arranged in the driver's seat and a digital camera. The data determined by means of the sensor and the camera, in particular, the position of the driver's head, are used together with the acoustic data of the passenger compartment of the motor vehicle, in order to derive an acoustic transfer function for the loudspeaker and simulate a virtual sound source.

A head related acoustic transfer function HRTF is based on the use of two loudspeakers, diverse coordinates of the sound space such as the delimitation and the shape of the passenger compartment, the time difference and the difference in height between the ears of the driver, and the outer shape of the ears. The driver's head must be determined exactly here. By means of the head related acoustic transfer function HRTF, a two-ear effect is generated, in order to simulate a virtual sound source.

The systems and methods known from the prior art are very complex and require a high level of technical effort in order to determine the position of the driver's head accurately, since the three-dimensional reproduction of the sound can only be correct if the driver's head has been determined exactly. In addition, in the conventional systems, only individual sounds are represented.

### SUMMARY

The aim of the invention is to provide a device and a method for reproducing audio signals in a motor vehicle. Here, the device should be able to freely position several sound sources, also referred to as sound objects, in a passenger compartment and dynamically change the positions thereof. The array of the sound source should be independent of the driver's head and thus also independent of the changeable position of the head. It should be possible to produce the device with minimal effort, and said device should comprise a minimal number of components and cause only minimal costs.

The aim is achieved by the subject matters having the features of the independent claims. Developments are indicated in the dependent claims.

The aim is achieved by a device according to the invention for reproducing audio signals in a passenger compartment of a motor vehicle. The device comprises at least one audio source and at least one loudspeaker for the emission of audio signals.

According to the idea of the invention, the device is designed as an object-based sound system with at least one signal processor and configured, for the generation of at least one virtual sound object, to generate the at least one audio source as a virtual sound object and arrange it freely in the passenger compartment and reproduce it, depending on direction and distance, in the three-dimensional space, and to dynamically change the position of the virtual sound object.

By means of the device, audio sources can be three-dimensionally reproduced, so that the occupants, in particular the driver, of the motor vehicle is/are given the impression that the respective audio signals of the audio sources are in each case emitted from a certain point of the surroundings, which is dynamically changeable depending on the situation.

According to a preferred design of the invention, the device for reproducing audio signals in a passenger compartment comprises sensors for acquiring the surroundings of the motor vehicle.

According to a development of the invention, the device is configured to generate a plurality of virtual sound objects separately and in each case arrange them freely in the passenger compartment and reproduce them, depending on direction and distance, in the three-dimensional space, and to dynamically change the positions of the virtual sound objects independently of one another. A plurality of sound objects is understood to mean at least two sound objects.

The aim is also achieved by a method according to the invention for reproducing audio signals with at least one virtual sound object in a motor vehicle with the device with at least one audio source and at least one loudspeaker for emitting audio signals. The method comprises the following steps:
receiving and processing of audio information of at least one audio source as well as
decomposing of the audio information by means of at least one signal processor for the generation of at least one virtual sound object based on an overall system, and
three-dimensional reproduction of the audio signal, wherein the at least one sound object is arranged in the three-dimensional sound space, and multiple three-dimensional sound waves for the at least one sound object are reproduced.

The method is advantageously used for reproducing multiple three-dimensional sound waves for a plurality of virtual sound objects which are arranged differently in the three-dimensional space. A plurality is understood to mean at least two sound objects.

Alternatively, a plurality of external audio sources, that is to say at least two audio sources, should also be considered.

According to an advantageous design of the invention, the method with a device with sensors for acquiring the surroundings of the motor vehicle comprises the following additional steps:
receiving of data on the surroundings of the motor vehicle (4) by means of sensors as well as
extracting and processing of the data acquired by the sensors in order to evaluate and take into consideration the surroundings of the motor vehicle (4) in the overall system, and
placement of the decomposed audio information in relation to the data of the surroundings of the motor vehicle (4) received by the sensors.

According to a preferred design of the invention, the at least one signal processor, taking into consideration the at least one sound object and acoustic properties of a sound space, calculates an individual audio signal for each loudspeaker.

The signal processor advantageously calculates the audio signals for each loudspeaker channel in such a manner that the audio signals, as sum signal, correspond to the sound field of a virtual point audio source. The signal processor transfers the data of the virtual audio source into discrete audio channels of the loudspeaker in order to reproduce the audio source exactly in a channel-independent manner. The levels are automatically generated dynamically by the signal processor.

In the process, a specific technical limitation of a channel-based system—and thus the formation of an optimal acoustic range in which the three-dimensional reproduction of the audio signal is correct only at a certain location relative to the loudspeakers is avoided.

The at least one signal processor calculates the individual audio signals for each loudspeaker advantageously taking into consideration the data of the surroundings of the motor vehicle.

According to a development of the invention, the reproduction of the multiple three-dimensional sound waves for the at least one sound object is based on a computation algorithm.

The computation algorithm is advantageously based on a wave field synthesis.

Another preferred design of the invention consists in replacing sound objects by other sound objects during the three-dimensional reproduction of audio signals.

According to another advantageous design of the invention, the data on the surroundings of the motor vehicle comprise data for determining the position, the travel direction and the type of the motor vehicle.

The device according to the invention and the method according to the invention for reproducing audio signals in a motor vehicle, in summary, comprises various advantages:
different audio sources are distinguishable at the reproduction site,
a virtual audio source can be associated with each incoming audio signal, and the virtual audio sources are reproduced separated from one another.
each audio source can be moved at the same time and independently of one another, and, via a conventional mixing of audio sources on the output channels, a dynamic interaction is produced, in which sound objects become active or present as a result of shifting and/or fading in and fading out,
the properties of the sound objects and the attributes of the audio sources can be modified on the reproduction side,
the audio sources can be completely distinguished three-dimensionally from one another on the reproduction side,
by adding sensor data, a three-dimensionally correct acoustic and abstract reproduction of the surroundings of the motor vehicle can be set up, the sound objects can be represented via acoustic signals,
several sound objects can be placed in the free space, wherein the sound sources are reproduced as if the sound objects were arranged in different directions and at different distances from the receiver, without in each case generating an optimal acoustic range specific for a sound object,
no head related acoustic transfer function HRTF and thus no exact determination of the head of the driver are necessary, since the sound waves are ostensibly generated outside of the sound space surrounded by the loudspeakers and for each individual passenger within the passenger compartment at the site of the virtual sound object,
listener, in particular driver of the motor vehicle, can very easily distinguish between different audio sources, concentrate on a specific audio source among all the specific audio sources, in a manner similar to the two-ear feature of headphones,
oral interaction is directed in a preferential viewing area of the driver, in order to keep the attention on the current driving situation and the road,
extension of the optimal acoustic range as well as
possibility of fading-in of individual sound objects, wherein other sound objects can be faded-out.

### BRIEF DESCRIPTION OF THE DRAWINGS

Additional details, features and advantages of designs of the invention result from the following description of embodiment examples in reference to the associated drawings. The drawings show:

FIG. 1a: a basis for a general mode of operation of a device for reproducing audio signals in the form of an object-based sound system with an array of loudspeakers and with a virtual sound object within the coordinate system, and a graph of an audio signal,

FIG. 1b: an array of loudspeakers of an object-based sound system in a motor vehicle,

FIGS. 2a-2c: a representation of the propagation of sound waves of two different sound objects using wave field synthesis,

FIG. 3: the process flow diagram of a method for reproducing audio signals with virtual sound objects,

FIGS. 4a-4f: application examples of the method for reproducing audio signals by the object-based system with virtual sound objects for the motor vehicle.

### DETAILED DESCRIPTION

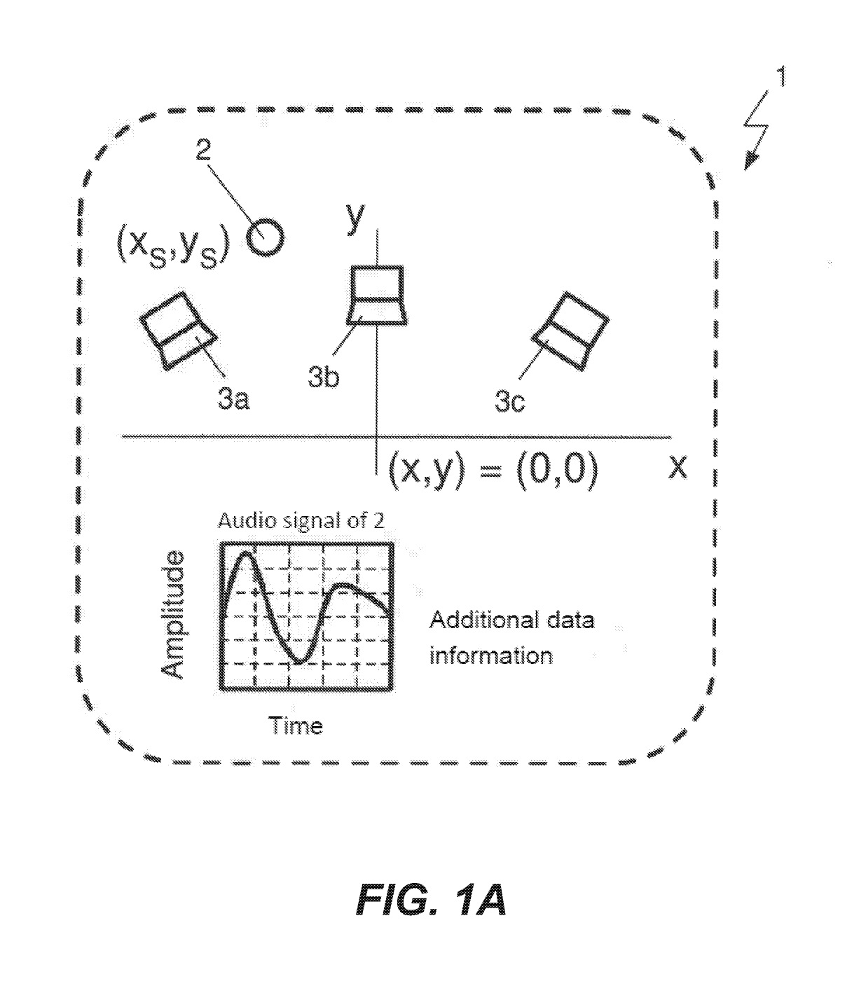

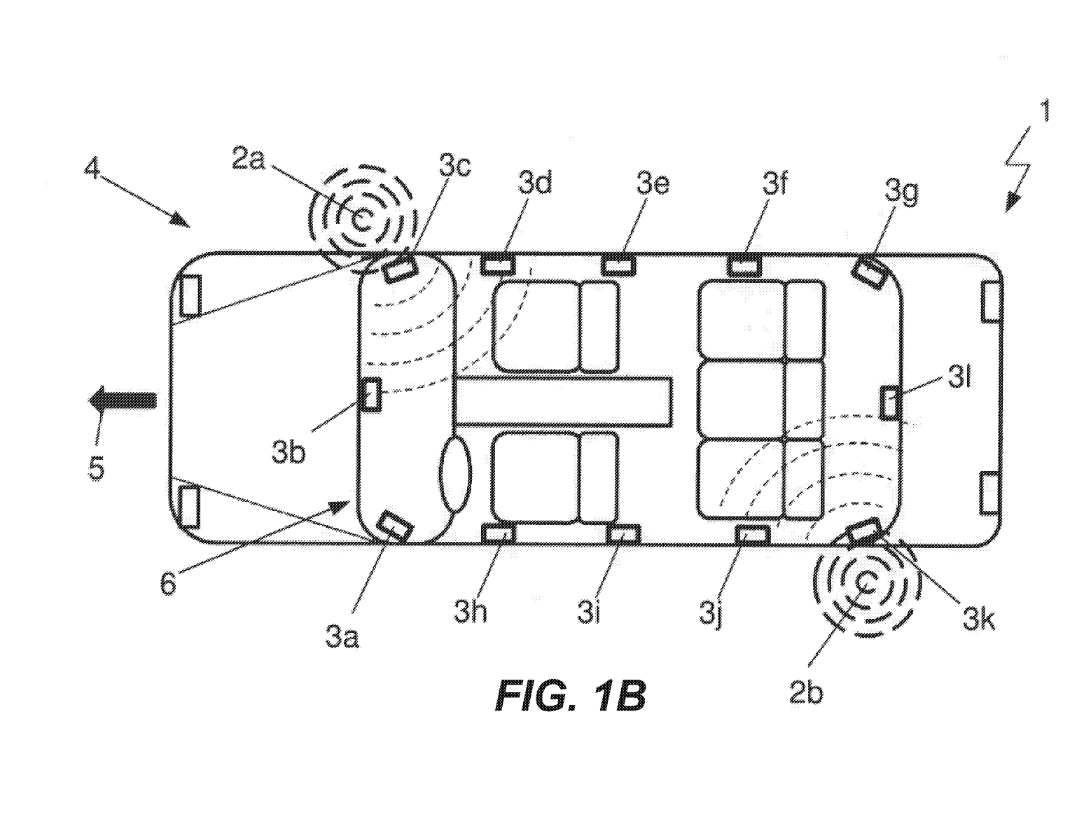

In FIG. 1a, a basis for a general mode of operation of a device 1 for reproducing audio signals, which is also referred to as an object-based sound system 1, is shown. The sound system 1 designed for generating at least one virtual sound object 2 comprises an array of loudspeakers 3a, 3b, 3c, which, together with the virtual sound object 2, are represented within a coordinate system having the coordinates x, y. The virtual sound object 2 is also referred to as virtual audio source.

The loudspeakers 3a, 3c arranged in each case next to the y axis of the coordinate system can be designed, for example, as right and left front loudspeaker within a motor vehicle. The loudspeaker 3b arranged on the y axis of the coordinate system would then have to be considered the center loudspeaker, which is positioned on a middle axis of the motor vehicle. The y axis and the middle axis of the motor vehicle are congruent. In this case, the virtual sound object 2 having the coordinates x_{S}, y_{S} is arranged on the driver side, for example, in a viewing direction of the driver.

Within the sound system 1, audio signals are generated and reproduced by the loudspeakers 3a, 3b, 3c. The audio signal is represented using the amplitude as a function of time in a diagram. In addition to the time-dependent amplitude of the audio signal, which is associated with the virtual sound object 2, within the device 1, the data information associated with the audio signal, also referred to as metadata, such as the position of the virtual sound object 2 using the coordinates x_{S}, y_{S}, the level, the frequency response, the audio source, and the phase relation with respect to other audio signals, are processed.

FIG. 1b shows an array of loudspeakers 3a to 3l of an object-based sound system 1 in a motor vehicle 4 moving in travel direction 5. In the process, two loudspeakers 3b, 3l are designed as center loudspeakers and in each case five loudspeakers 3a, 3c-3g, 3h-3k are designed as side loudspeakers. The loudspeaker 3b designed as a front loudspeaker and the loudspeaker 3k designed as a rear loudspeaker are arranged on the middle axis of the motor vehicle 4.

In FIG. 1b, two different virtual sound objects 2a, 2b are represented, which are positioned, on the one hand, in travel direction 5 of the motor vehicle 4 to the right in front and to the left in the rear. The respective audio signals of the virtual sound objects 2a, 2b are emitted substantially from the loudspeakers 3c, 3k arranged to the side on the right in front and to the side on the left in the rear. The driver perceives the audio signals from the indicated directions.

By means of the object-based sound system 1, space related information of different sounds and sound waves can be processed separately, and different sound objects 2a, 2b can be generated separately. The sound objects 2a, 2b can be arranged independently of one another in the space.

By means of a computation algorithm, the virtual sound objects 2a, 2b are decomposed in real time and arranged, depending on the application, within or outside of the passenger compartment. Here, an adaptation of the sound to the respective parameters of the vehicle, particularly of the passenger compartment, is possible.

For each sound object 2a, 2b, for example, by means of wave field synthesis or another computation algorithm, three-dimensionally propagating sound waves can be generated. This enables each individual listener to separate each sound object 2a, 2b and concentrate on each sound object 2a, 2b.

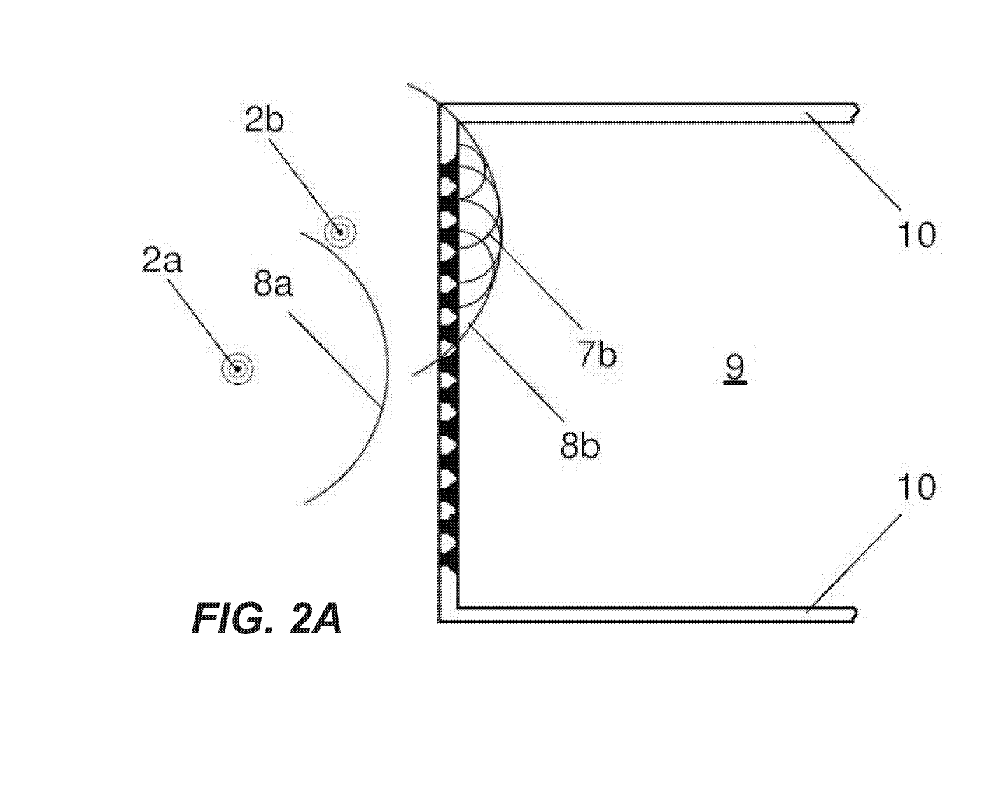

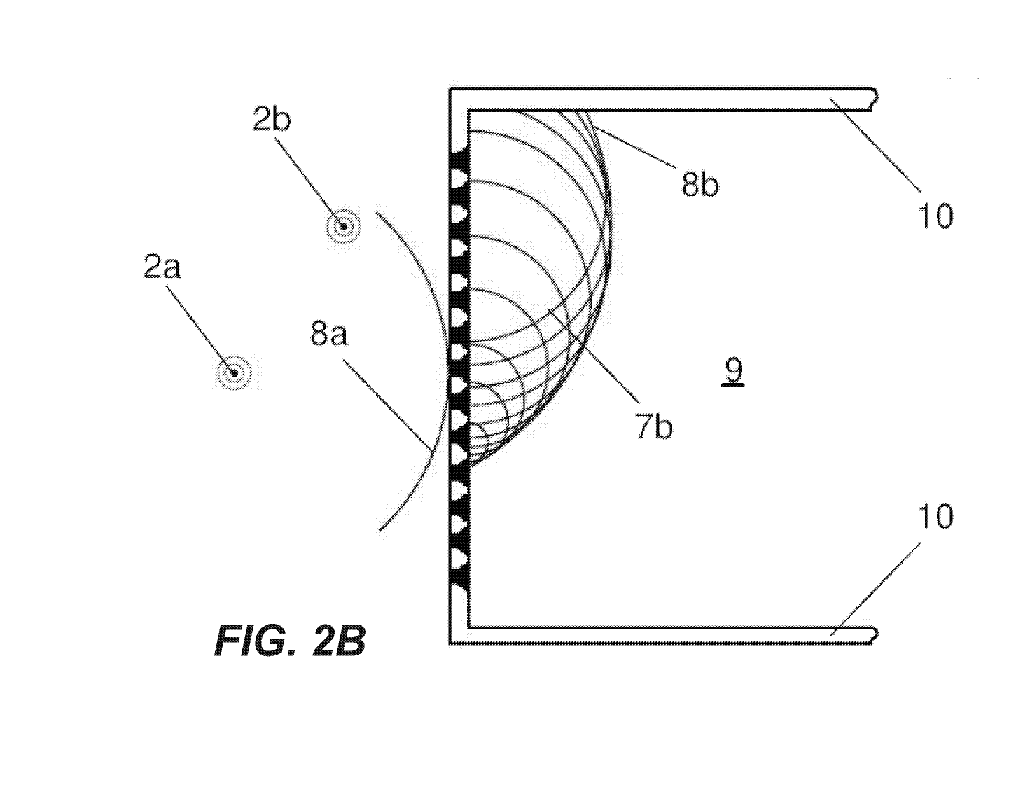

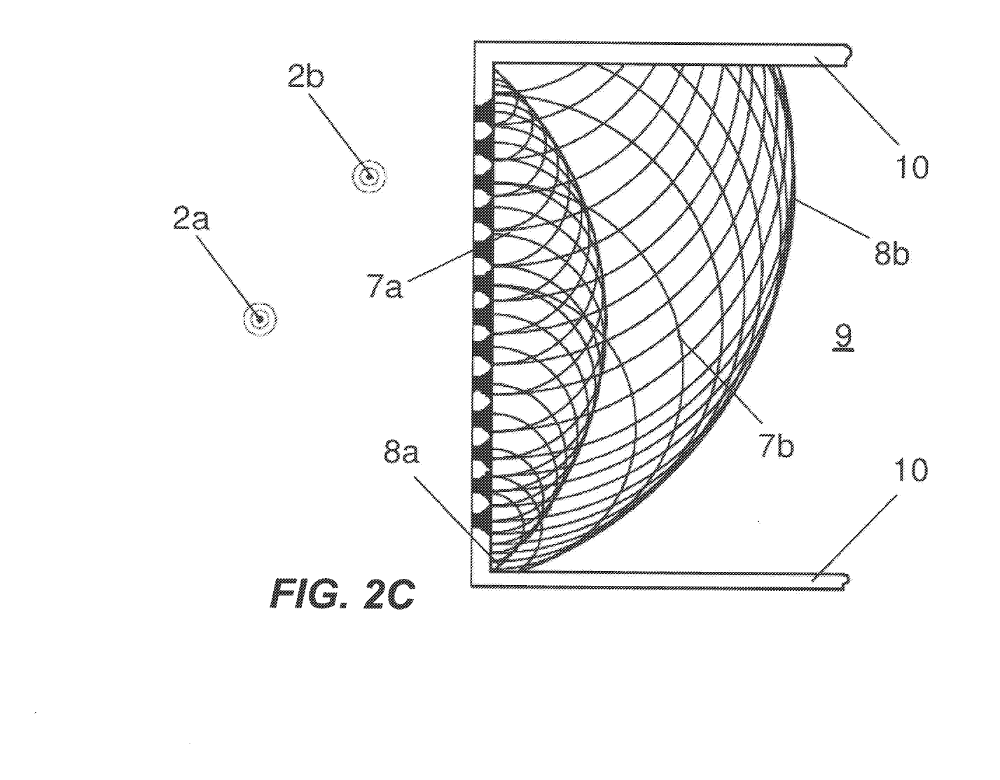

FIG. 2a to 2c are the representation of the propagation of the sound waves of two different sound objects 2a, 2b using wave field synthesis. Wave field synthesis is a three-dimensional audio reproduction method and is used to provide virtual acoustic environments. In wave field synthesis, wave fronts 8a, 8b are generated, which originate from a virtual sound object 2a, 2b. The acoustic localization of the virtual sound objects 2a, 2b here is not dependent on the position of the listener or on psychoacoustic effects.

In wave field synthesis, each wave front 8a, 8b is considered a superposition of elementary waves 7a, 7b which propagate in a sound space 9. Here, each point of a wave front 8a, 8b is a starting point of an elementary wave 7a, 7b. From the elementary wave 7a, 7b, any wave front 8a, 8b can be synthesized.

For example, on a perforated wall as a section of a boundary 10 of the sound space 9, arranged between a sound source and a listener as receiver of the sound, elementary waves 7a, 7b arise. On the perforated wall, the wave front 8a, 8b is decomposed into elementary waves 7a, 7b. After penetration through the wall, the elementary waves 7a, 7b join again to form a wave front 8a, 8b.

The elementary waves 7a, 7b, which are part of a wave front 8a, 8b of any desired virtual sound object 2a, 2b, are calculated using complex mathematical procedures. The wave front 8a, 8b to be synthesized is here decomposed by means of a signal processor, in short also referred to as a renderer, into a number of elementary waves 7a, 7b corresponding to the reproduction conditions. Via a plurality of channels and differently controlled loudspeakers, elementary waves 7a, 7b can be generated, which synthesize any desired wave fronts 8a, 8b. In the process, all the loudspeakers can be designed to be active and identical and cover the entire audible frequency range. Each loudspeaker can be designed with a separate amplifier and optionally also with a separate digital signal processor.

Taking into consideration the virtual sound objects 2a, 2b, the acoustic properties of the sound space 9 and the data of the surroundings of the motor vehicle, the signal processor computes a corresponding individual audio signal for each individual loudspeaker.

The virtual sound objects 2a, 2b or the sound sources which reproduce the signal of the associated channels can be arranged outside of the sound space 9 as a reproduction space. The arrangement outside of the sound space 9 decreases the influence of the position of the listener, since the relative changes of angle of incidence and level are clearly smaller than in the case in which the loudspeakers 3a to 3l located close by. As a result, the optimal acoustic range is extended, potentially extending over the entire sound space 9, particularly the entire passenger compartment.

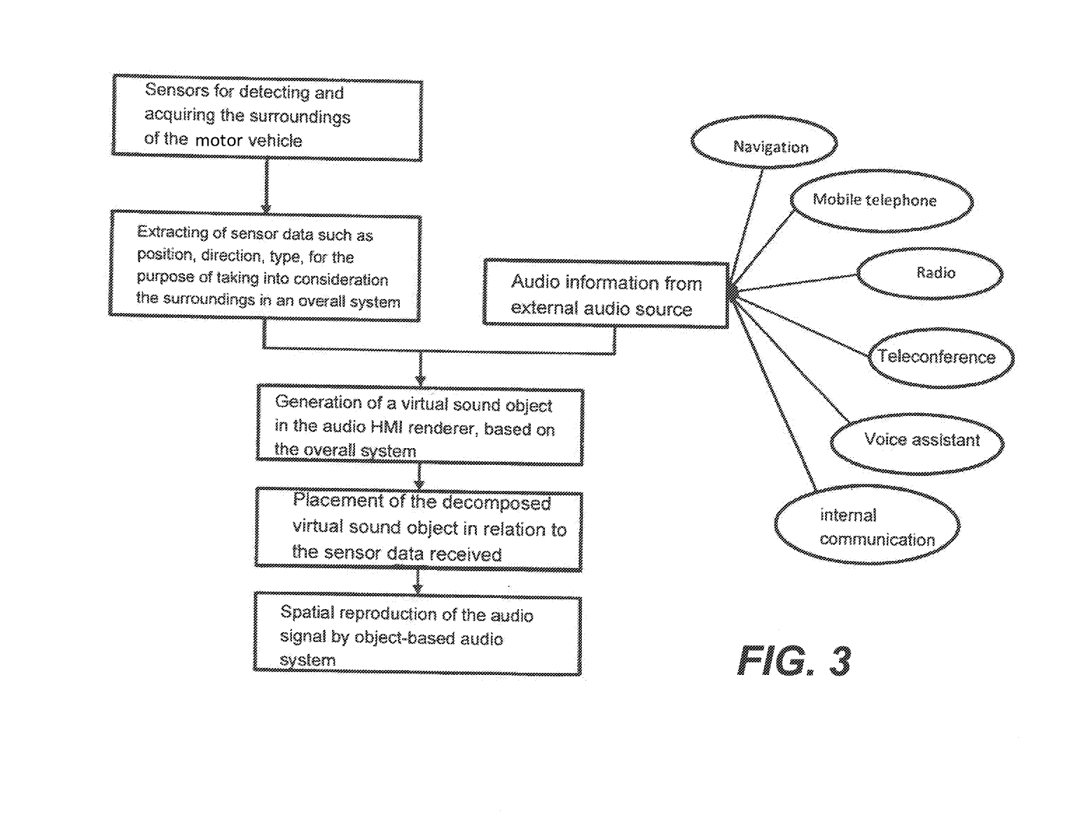

FIG. 3 shows the process flow diagram of a method for reproducing audio signals with virtual sound objects 2a, 2b. The method is based here on the processing of information of external audio sources such as information of a navigation system, of a mobile telephone, of a radio, of a voice assistant, with regard to a teleconference or an internal communication, as well as data on the surroundings of the motor vehicle. In a teleconference, for example, the external participants are represented by virtual sound objects. In the case of internal communication, the occupants, in particular the driver and a front-seat passenger, communicate via an internal system with one another. In the process, for example, the voice of a person seated in the rear area can also be superposed with a video image in the front area or can resound and be amplified from the actual position of the front seat passenger.

The information of the external audio sources comprises, for example, the temporal course of the amplitude of the audio signal, and the metadata associated with the audio signal, such as the level or the frequency response.

The device 1 comprises sensors for detecting and acquiring the surroundings of the motor vehicle. The data acquired by the sensors are extracted and processed in order to evaluate and take into consideration the surroundings of the motor vehicle in an overall system. In the process, for example, data for determining the position, the travel direction or the type of the motor vehicle are used.

The audio information of the external audio sources is decomposed within an audio HMI renderer for the generation of a virtual sound object 2a, 2b based on the overall system. HMI here refers to a human machine interface. Subsequently, the decomposed virtual sound object 2a, 2b is placed in relation to the data received by the sensor, within the device 1.

The audio signal is subsequently reproduced three-dimensionally by means of the object-based sound system 1.

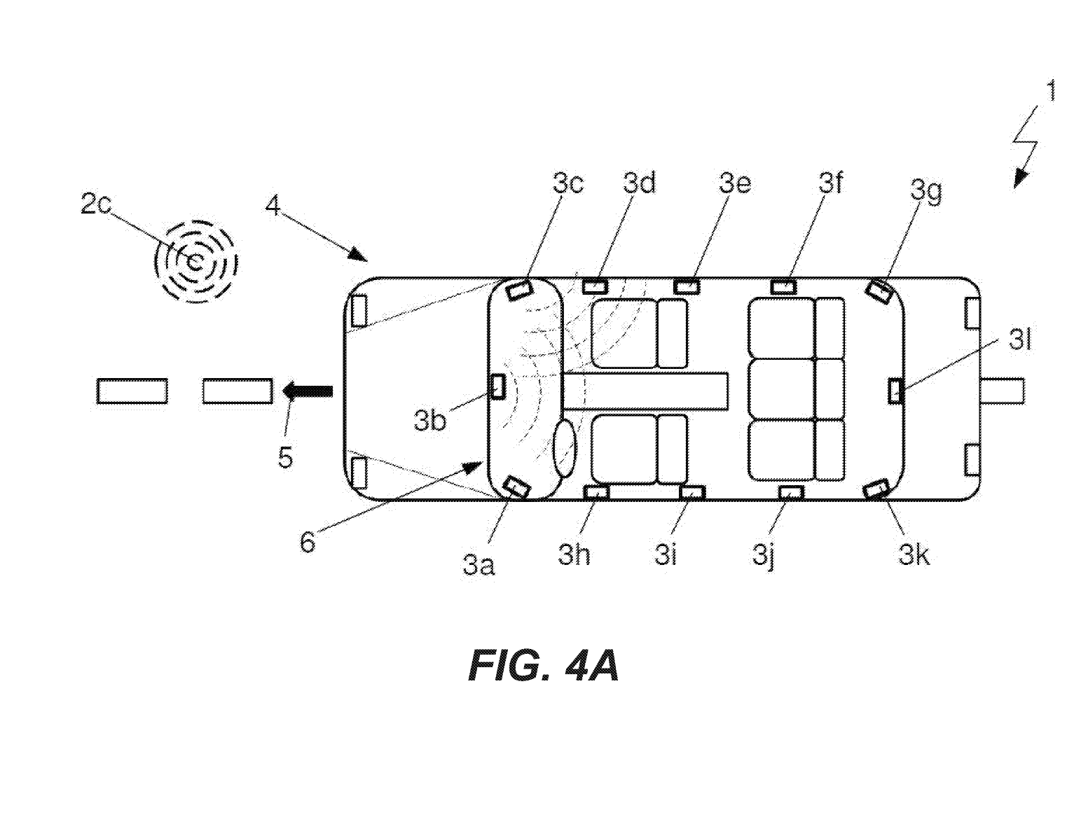

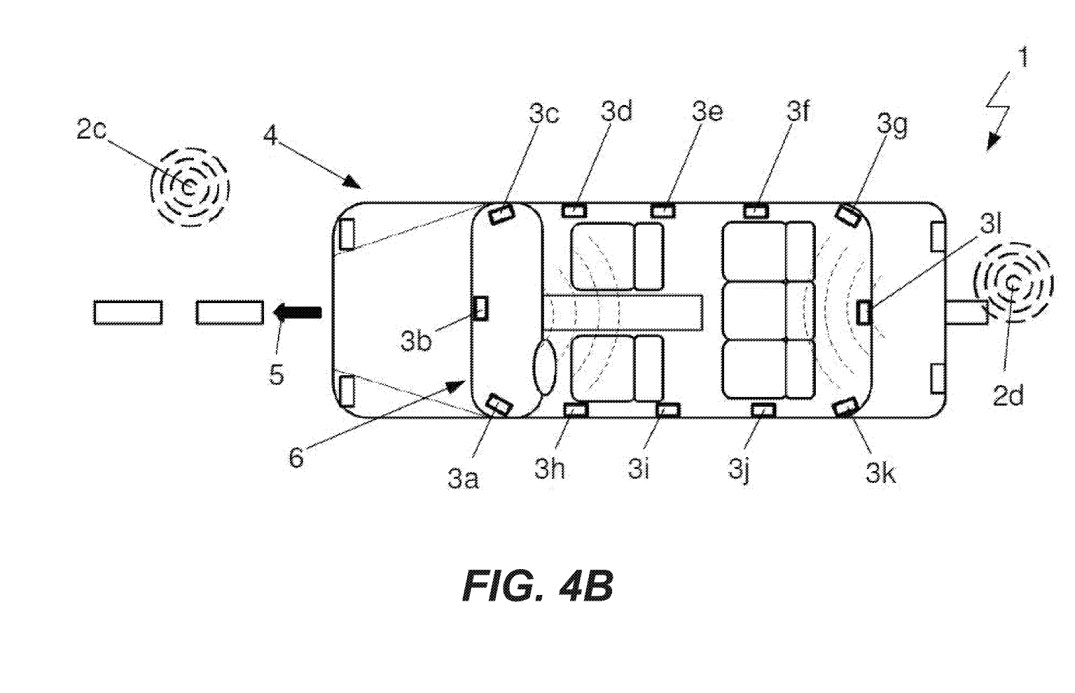

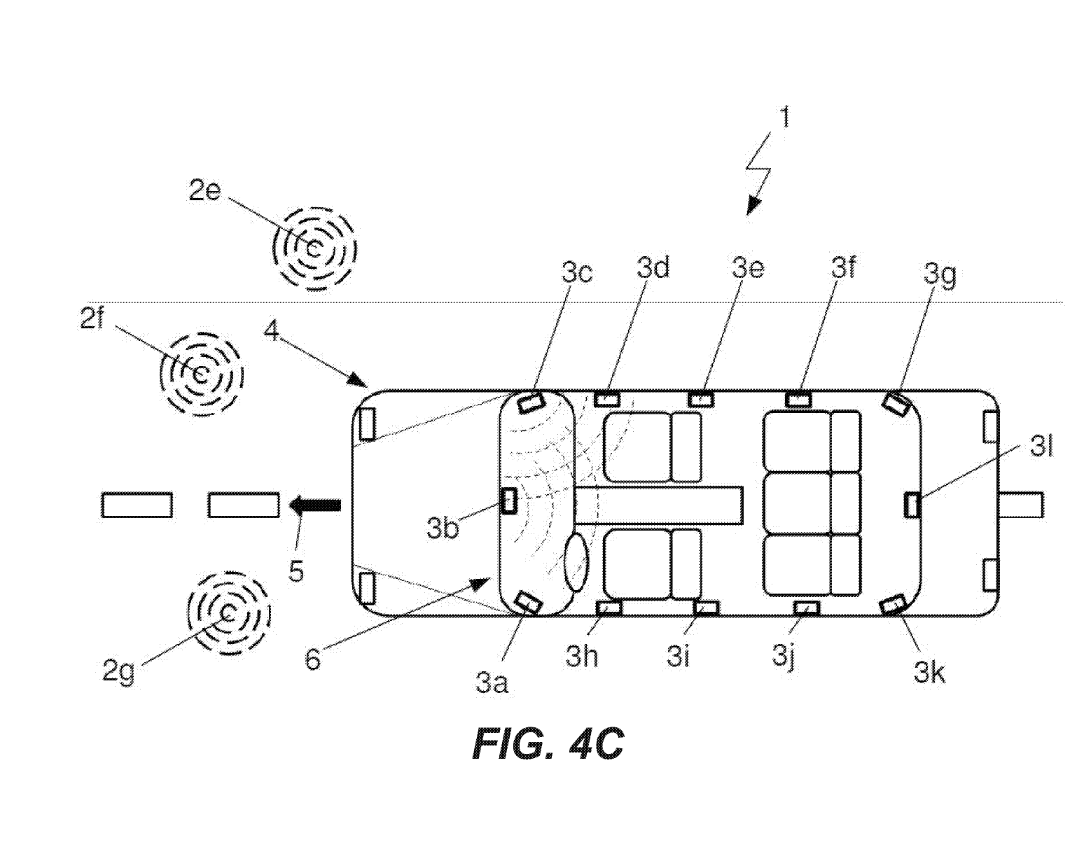

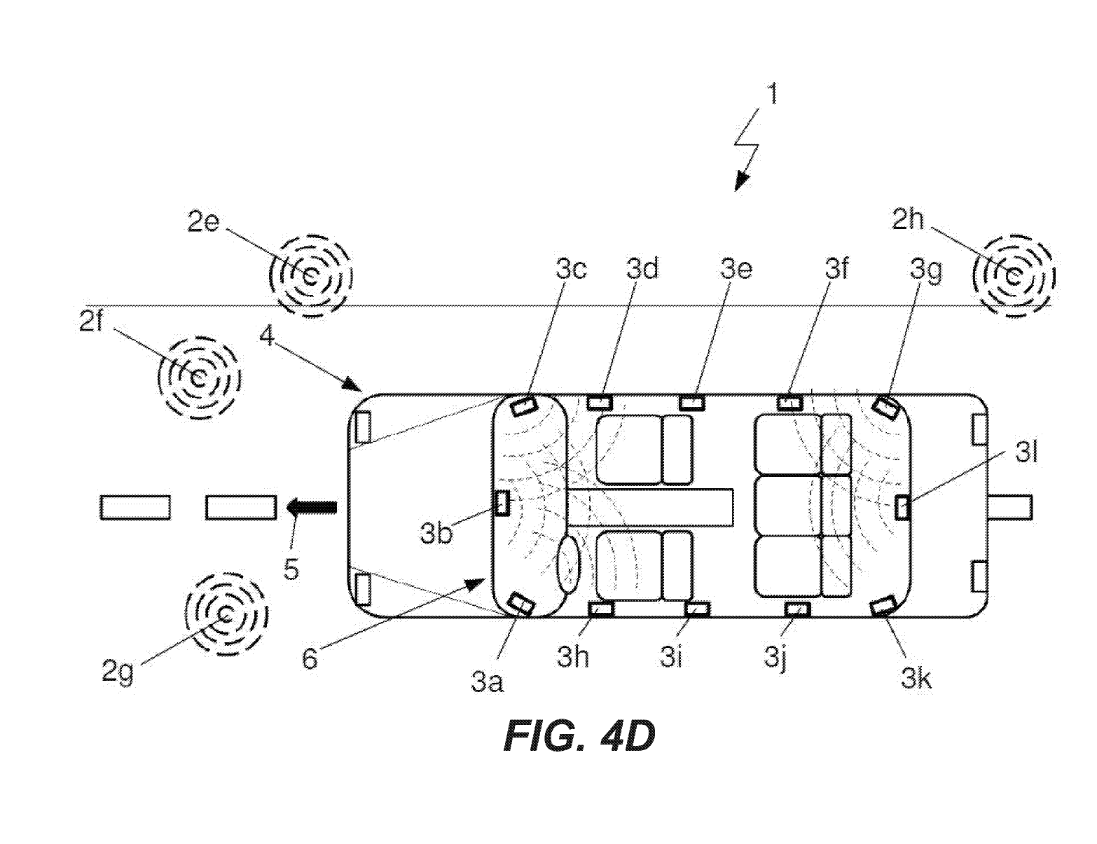

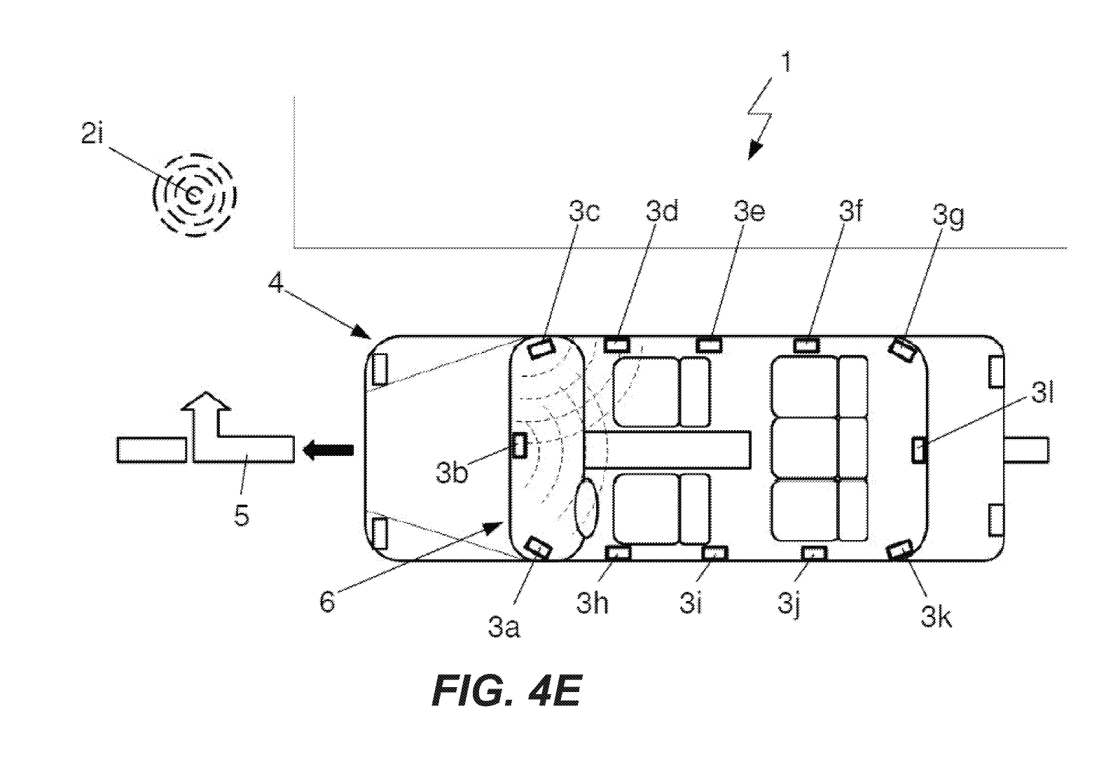

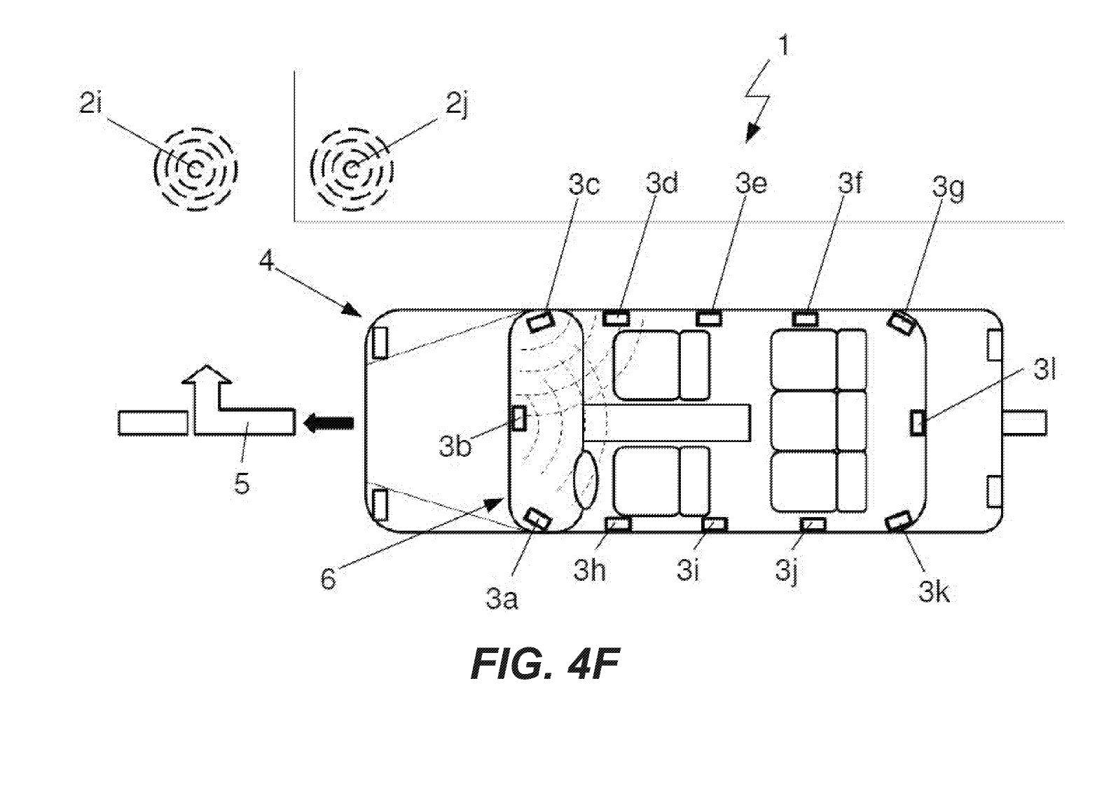

In FIG. 4a to 4f, application examples of the method for reproducing audio signals by the object-based sound system 1 with virtual sound objects 2c to 2i for the motor vehicle 4 are shown.

In FIG. 4a, the virtual sound object 2c is arranged to the right in front in travel direction 5 of the motor vehicle 4 in front of the motor vehicle 4. From the indicated direction, the vehicle occupants, in particular the driver, perceive the audio signals. In the process, the virtual sound object 2c is, for example, reproduced as the voice of a participant of a telephone conversation with one of the vehicle occupants, as a voice for outputting traffic information or information of a navigation system. The voice of the virtual sound object 2c is emitted substantially by the loudspeaker 3c arranged to the side on the right in front and by the front center loudspeaker 3b.

In contrast to the application of FIG. 4a, in the application example according to FIG. 4b, behind the passenger compartment, an additional virtual sound object 2d is arranged, which, for example, emits audio signals for reproducing music. While, in the front area, as a virtual sound object 2c, a voice for the reproduction of information or for a conversation resounds, music is played in the rear area of the passenger compartment. The voice of the virtual sound object 2c appears substantially to be emitted by the loudspeakers 3a, 3c arranged to the side on the right in front and on the left in front, as well as by the front center loudspeaker 3b, while it appears that the music of the virtual sound object 2d is emitted substantially by the loudspeakers 3g, 3k arranged to the side on the right in the rear and on the left in the rear, as well as the rear center loudspeaker 3l. However, the wave components are emitted by all the loudspeakers 3a to 3l, in order to achieve the corresponding sound image.

In FIG. 4c, three virtual sound objects 2e, 2f, 2g are distributed in the travel direction 5 of the motor vehicle 4 in front of the motor vehicle 4 and arranged spaced apart from one another. The virtual sound objects 2e, 2f, 2g are here reproduced, for example, as voices of participants of a teleconference or audio signals of a music band. With the object-based sound system 1, a teleconference can be reproduced, which is based on data transmission per Internet protocol.

When several audio sources of a teleconference are added, each participant can be reproduced as a separate audio source. In the process, the spatiality can be advantageously reproduced correctly and completely for each speaker at each site in the motor vehicle, which enables the listener to concentrate on individual audio sources and distinguish the contents thereof.

In object-based playing back of the music as in a stage setup of the band, the driver perceives the exact positions of the members of the band and of the instruments, such as a guitarist with guitar, a singer, and a drummer with trap set. The members of the teleconference or the music bands are perceived as virtual sound objects 2e, 2f, 2g emitted substantially by the loudspeakers 3a, 3c arranged to the side on the right in front and to the side on the left in front and by the front center loudspeaker 3b and thereby appear to be emitted in the front area of the passenger compartment.

In contrast to the application of FIG. 4c, in the application example according to FIG. 4d, an additional virtual sound object 2h is arranged behind the passenger compartment, which is emitted, for example, as the voice of a singer of the music band. While in the front area, via the virtual sound objects 2e, 2g, the guitarist with the guitar and the drummer with the trap set can still be perceived, the voice of the singer is apparently played back in the rear area of the passenger compartment.

In object-based playing back of audio signals, certain sound objects 2f can be replaced by other sound objects, in particular also audio signals of other audio sources. In the application example from FIG. 4d, for example, the voice of the band's singer is replaced by a voice of the navigation system for the reproduction of traffic information or of a participant in a telephone conversation, while the other positions of the band members and instruments remain unchanged. The singer is perceived via the virtual sound object 2h in the rear area of the passenger compartment.

In FIG. 4e, a virtual sound object 2i is arranged, in the travel direction 5 of the motor vehicle 4, in front of the motor vehicle 4 to the right in front. The virtual sound object 2i is reproduced, in the process, for example, as the voice of a navigation system, which resounds from a travel direction 5 of the motor vehicle 4 to be assumed and proposed by the navigation system and which is thus upcoming. The voice of the virtual sound object 2i appears to be emitted substantially by the loudspeaker 3c arranged to the side on the right in front and by the front center loudspeaker 3b.

In contrast to the application from FIG. 4e, in the application example according to FIG. 4f, an additional virtual sound object 2j is arranged in front of the passenger compartment and emits, for example, audio signals for reproducing music. The virtual sound objects 2i, 2j are each arranged in a travel direction 5 of the motor vehicle 4 to be assumed and proposed by the navigation system and which is thus upcoming.

What is claimed is:

1. A system for reproducing audio signals in a passenger compartment of a vehicle, comprising:
at least one audio source;
at least one loudspeaker to project sound from the at least one audio source, and
a processor configured to:
receive data on a location of a sound received by the at least one audio source,
generate a virtual sound object from the sound, and
dynamically change the position of the virtual sound object based on a movement of the vehicle.

2. The system according to claim 1, wherein the at least one audio source is configured to receive sound from outside the vehicle.

3. The system according to claim 1, wherein the device is configured to generate a plurality of virtual sound objects separately, wherein each of the plurality of virtual sound object corresponds to a unique sound, and the processor is further configured to dynamically change for each of the plurality of virtual sound objects the position based on the movement of the vehicle.

4. The system according to claim 1, further comprising at least two loudspeakers, wherein the data from the audio source further includes data including a location of a first source of sound and a second source of sound, wherein the processor is further configured to replicate the location of the first source of the sound and the second source of the sound based on the at least two loudspeakers.

5. The system according to claim 1, further comprising the processor being further configured to be electronically coupled to a navigation system, wherein the processor is configured to determine a location associated with the navigation system's transmitted instructions, and to produce the virtual sound object associated with the transmitted instructions based on the location of the associated transmitted instructions and the location of the vehicle.
